(19) United States
(12) Patent Application Publication
(10) Pub. No.: US 2010/0054520 A1
(43) Pub. Date: Mar. 4, 2010

(54) Loudspeaker

(76) Inventor: Jason Myles Cobb, Odessa, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 12/230,354

(22) Filed: Aug. 28, 2008

(51) Int. Cl. H04R 1/02

(52) U.S. Cl. 381/386

(57) ABSTRACT

A loudspeaker including a bottom plate formed from a material capable of transmitting a magnetic flux. The bottom plate has a bottom portion and a first side portion that is affixed to, and extends upwardly from, the periphery of the bottom portion. A magnet is affixed to, and extends upwardly from, the center of the bottom portion. A top plate, formed from a material capable of transmitting a magnetic flux, has a top portion that is affixed to, and extends outwardly from, the top of the magnet. The top plate also has a second side portion that is affixed to, and extends downwardly from, the periphery of the top portion. The second side portion is laterally spaced away from the first side portion so as to define a first air gap between the second side portion and the first side portion. The second side portion is laterally spaced away from the magnet so as to define a second air gap between the second side portion and the magnet. The second side portion is vertically spaced away from the bottom portion so as to define a passageway between the second side portion and the bottom portion. The first air gap and the second air gap are placed in fluid communication by the passageway. A diaphragm for producing audible sounds includes a bobbin portion that is positioned within the first air gap and is capable of free movement therein. A conical portion is affixed to the top of the bobbin portion remote from the first air gap. A voice coil is wound around, and is affixed to, the bobbin portion within the first air gap.

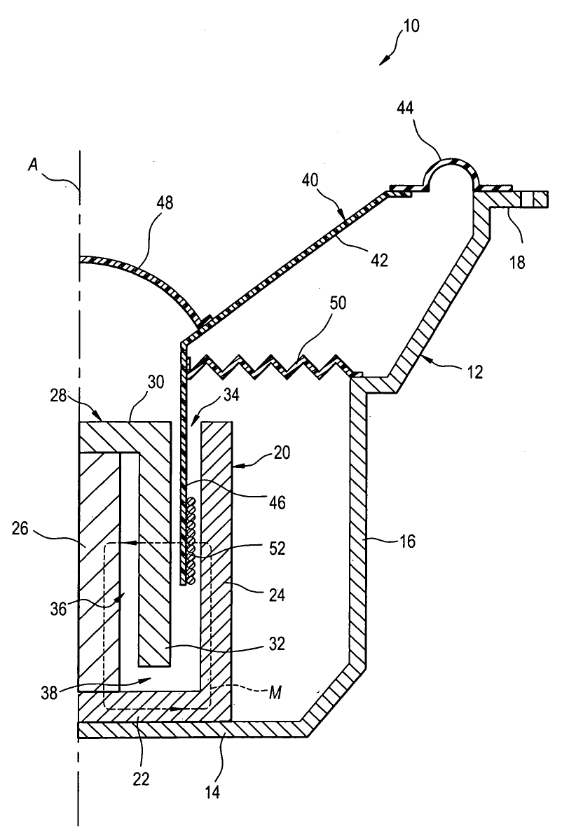

### FIELD OF THE INVENTION

The present invention relates generally to electrical audio signal processing systems and devices and, more particularly, to electro-acoustic audio transducers.

### BACKGROUND OF THE INVENTION

A conventional loudspeaker has a conical diaphragm that is vibrated over a range of frequencies to generate audible sounds. The diaphragm moves forwardly and rearwardly from its resting position with the full range of motion being known as “peak-to-peak excursion.” As the peak-to-peak excursion of the diaphragm increases, so does its ability to produce louder sounds, especially at lower frequencies.

Peak-to-peak excursion of a loudspeaker diaphragm is often made larger by lengthening the magnetic components that drive the diaphragm. Nonetheless, small cabinets and other mounting structures restrict the sizes and weights of magnetic components in loudspeakers. Thus, the sound produced by many loudspeakers is less than satisfactory in terms of its quality and its volume.

### SUMMARY OF THE INVENTION

In light of the problems associated with known loudspeakers, it is a principal object of the invention to provide a loudspeaker of compact size that can produce large sounds at minimal cost and in space-restricted situations. The new loudspeaker can exceed the output (in terms of volume, frequency range, and sound quality) of a substantially larger, heavier, and costlier loudspeaker of conventional construction.

It is another object of the invention to provide a loudspeaker of the type described that efficiently dissipates heat that can lead to breakdowns and reduce the loudspeaker's useful lifespan.

It is an object of the invention to provide improved features and arrangements thereof in a loudspeaker for the purposes described that is lightweight in construction, inexpensive to manufacture, and dependable in use.

The foregoing and other objects, features, and advantages of the present loudspeaker will become readily apparent upon further review of the following detailed description of the preferred embodiments as illustrated in the accompanying drawings.

### BRIEF DESCRIPTION OF THE DRAWINGS

My invention can be more readily described with reference to the accompanying drawing that is a vertical, partial, cross-sectional view of a new loudspeaker.

### DETAILED DESCRIPTION OF THE LOUDSPEAKER

Referring now to the FIGS., a loudspeaker in accordance with the present invention is shown at 10. Loudspeaker 10 includes a frame 12 having a bottom wall 14 and a side wall 16 that extends upwardly from the periphery of bottom wall 14. Bottom wall 14 is a large disk. Side wall 16 is a hollow cylinder and is provided, at its top remote from bottom wall 14, with an outwardly extending, mounting flange 18.

A bottom plate 20 is affixed to frame 12. Bottom plate 20 is formed from a material that can transmit a magnetic flux, like iron, and includes a bottom portion 22 and a side portion 24 that is affixed to bottom portion 22. Bottom portion 22 is a small disk that is positioned at the center of bottom wall 14. Side portion 24 is a hollow cylinder that extends upwardly from the periphery of bottom portion 22 and partially to the open top of frame 12 so as to form a cup-shaped feature.

A permanent magnet 26 is positioned within bottom plate 20. Magnet 26 is a solid, cylindrical rod whose bottom is positioned upon the center of bottom portion 22 and whose central, longitudinal axis A is the same as the central, longitudinal axis of side portion 24. Magnet 26 has a diameter that is less than that of bottom portion 22 and height that is less than that of side portion 24 so that magnet 26 is fully contained within bottom plate 20. Magnet 26 engages bottom portion 22 so as to magnetically couple magnet 26 and bottom plate 20 whereby magnetic flux readily passes from one to the other.

A top plate 28 is affixed to the top of magnet 26. Top plate 28 is formed from a material that can transmit a magnetic flux, like iron, and includes a top portion 30 and a side portion 32 that is affixed to top portion 30. Top portion 30 is a disk that has an outer diameter that is greater than that of magnet 26 yet is less than the inner diameter of side portion 24. As shown, top portion 30 is centered atop magnet 26 such that its central, longitudinal axis A is the same as that of magnet 26. Side portion 32 is a hollow cylinder that extends downwardly from the periphery of top portion 30 and partially to the top of bottom portion 22 so as to form an inverted, cup-shaped feature that partially encloses magnet 26.

Top portion 30 projects outwardly from magnet 26 and partially toward side portion 24 thereby leaving a first annular space or outer magnetic gap 34 between top portion 30 and side portion 24. Side portion 32, having an outer diameter that is the same as that of top portion 30, extends outer magnetic gap 34 downwardly toward bottom portion 22. Magnetic flux M passes through outer magnetic gap 34 between side portion 32 of top plate 28 and side portion 24 of bottom plate 20.

Side portion 32 has an inner diameter that is greater than the outer diameter of magnet 26 so as to define a second annular space or inner magnetic gap 36 between side portion 32 and magnet 26. Magnetic flux M passes through inner magnetic gap 36 between side portion 32 of top plate 28 and magnet 26. Air is free to circulate within the inner magnetic gap 36 and cool magnet 26 during use of loudspeaker 10.

Side portion 32 has a height that is less than that of magnet 26 so that a passageway 38 is formed between the bottom of side portion 32 and the top of bottom portion 22. Air travels via passageway 38 between outer magnetic gap 34 and inner magnetic gap 36 to enhance the cooling of magnet 26.

A magnetic circuit is formed by bottom plate 20, magnet 26, and top plate 28 that generates magnetic flux M. The magnetic flux M passes from magnet 26 and into, and through, bottom portion 22 and side portion 24. From side portion 24 the magnetic flux M traverses outer magnetic gap 34 to reach side portion 32. Then, magnetic flux M extends across inner magnetic gap 36 to return to magnet 26 thereby completing the circuit.

A diaphragm 40 is affixed to frame 12. Diaphragm 40 has a conical portion 42 that is connected at its wide, open, top end to flange 18 by a resilient surround 44 and whose tapered bottom end is suspended above top plate 28. Diaphragm 40 also has a bobbin portion 46 that is affixed to the bottom end of conical portion 42. Bobbin portion 46 is a hollow cylinder that extends downwardly from conical portion 42 into outer magnetic gap 34 in such a manner that bobbin portion 46 can be freely moved up and down parallel to axis A. A capping portion 48 is affixed to the bottom of conical portion 42 to close the open, bottom end of conical portion 42.

A corrugated spider 50 supports diaphragm 40. Spider 50 encircles the top of bobbin portion 46 and extends outwardly therefrom to engage frame 12. Spider 50 is connected to both bobbin portion 46 and side wall 16.

A voice coil 52 encircles bobbin portion 46 and is positioned in outer magnetic gap 34 in such a manner that it will not impede the axial movement of bobbin portion 46. Magnetic flux M is applied to voice coil 52 by side portions 24 and 32. When an electrical current corresponding to an audio signal is applied to voice coil 52, voice coil 52 vibrates in a manner that causes diaphragm 40 to move cyclically and parallel to axis A thereby generating sounds corresponding to the audio signal. Heat produced in the process of generating sounds is shed from loudspeaker 10 by the movement of air through magnetic gaps 34, 36 and passageway 38.

While loudspeaker 10 has been described with a high degree of particularity, it will be appreciated by those skilled in the field that modifications can be made to it. Thus, it is to be understood that the present invention is not limited merely to loudspeaker 10, but encompasses any and all loudspeakers within the scope of the following claims.

I claim:

1. A loudspeaker, comprising:
a bottom plate being formed from a material capable of transmitting a magnetic flux, said bottom plate including:
a bottom portion; and,
a first side portion being affixed to, and extending upwardly from, the periphery of said bottom portion;
a magnet being affixed to, and extending upwardly from, the center of said bottom portion and being remote from said first side portion;
a top plate being formed from a material capable of transmitting a magnetic flux, said top plate including:
a top portion being affixed to, and extending outwardly from, the top of said magnet; and,
a second side portion, being affixed to, and extending downwardly from, the periphery of said top portion, said second side portion being laterally spaced away from said first side portion so as to define a first air gap between said second side portion and said first side portion, said second side portion being laterally spaced away from said magnet so as to define a second air gap between said second side portion and said magnet, said second side portion being vertically spaced away from said bottom portion so as to define a passageway between said second side portion and said bottom portion, and said first air gap and said second air gap being placed in fluid communication by said passageway;
a diaphragm for producing audible sounds, said diaphragm including:
a bobbin portion being positioned within said first air gap and being capable of free movement therein; and,
a conical portion being affixed to the top of said bobbin portion remote from said first air gap; and,
a voice coil being wound around, and being affixed to, said bobbin portion within said first air gap.
